(19) United States
(12) Patent Application Publication
(10) Pub. No.: US 2024/0124168 A1
(43) Pub. Date: Apr. 18, 2024

(54) Unmanned aircraft with increased reliability and method for piloting such an unmanned aircraft

(71) Applicants: THALES, COURBEVOIE (FR); ISSOIRE AVIATION, LE BROC (FR)

(72) Inventors: Eric GUILLOUET, TOULOUSE (FR); Romain KLUR, ISSOIRE (FR); Philippe MONIOT, ISSOIRE (FR); Pierre GUTIERREZ, ISSOIRE (FR)

(21) Appl. No.: 18/547,032

(22) PCT Filed: Feb. 21, 2022
(86) PCT No.: PCT/EP2022/054231

§ 371 Date: Aug. 18, 2023

(30) Foreign Application Priority Data
Feb. 21, 2021 (FR) 2101680

(51) Int. Cl. B64U 10/25; B64D 27/31; B64U 50/13; B64U 50/18; B64U 50/19

(52) U.S. Cl. CPC B64U 10/25; B64D 27/31; B64U 50/13; B64U 50/18; B64U 50/19; B64U 2201/20

(57) ABSTRACT

An aircraft includes an airframe including a fuselage, a wing, and a tail, a main propulsion unit, including a motor and a propeller, a flight control device, including electric actuators, movable surfaces and sensors, and an autopilot computer sending instructions to the main propulsion unit and to the flight control device. Such unmanned aircraft further includes a pair of auxiliary propulsion units, each auxiliary propulsion unit including an electric motor, a propeller driven by the electric motor, and means for orienting the plane of the propeller with respect to the airframe, the flight control computer being programmed for setting a steering angle and a propeller speed of each auxiliary propulsion unit so as to compensate for a malfunction of the flight control system and/or of the main propulsion unit, in order to control the trajectory along all axes, the unmanned aircraft thereby exhibiting increased reliability.

### CROSS-REFERENCE TO RELATED APPLICATIONS

This application claims benefit under 35 USC § 371 of PCT Application No. PCT/EP2022/054231 entitled UNMANNED AIRCRAFT WITH INCREASED RELIABILITY AND METHOD FOR PILOTING SUCH AN UNMANNED AIRCRAFT, filed on Feb. 21, 2022 by inventors Eric Guillouet, Romain Klur, Philippe Moniot and Pierre Gutierrez. PCT Application No. PCT/EP2022/054231 claims priority of French Patent Application No. 21 01311, filed on Feb. 11, 2021.

### FIELD OF THE INVENTION

The present invention relates to an unmanned aircraft of the type including: an airframe including a fuselage, a wing, and a tail; at least one main propulsion unit, consisting of at least one motor and at least one propeller; a flight control device, including a plurality of electric actuators, movable surfaces and sensors; and an autopilot computer apt to send instructions to the main propulsion unit and to the flight control device.

### BACKGROUND OF THE INVENTION

The present invention relates in particular to an aircraft such as an airplane.

An airplane, i.e. a fixed-wing aircraft without a crew is called an “UAV” (for “Unmanned Aircraft Vehicle”) or, more generally, an “aerial drone”.

The level of safety of existing aerial drones is insufficient for the use thereof in non-segregated airspace (i.e. an airspace which is not reserved exclusively for the movement of the drone) and/or above populations.

In order to be allowed to carry out such operations, aerial drones will have to be certified to ensure that same have a level of safety equal to or higher than the level of safety of manned aircraft.

According to the latest developments of the upcoming regulations for aerial drones flying over populated areas, the demonstration that the probability of occurrence of any event leading to the loss of control of the aerial drone is less than 10⁻⁷, preferentially than 10⁻⁸, per flight hour, will be required.

In the aviation sector, such a level of reliability is normally achieved by the redundancy of the critical systems on-board so as to cope with one or a plurality failures or malfunctions. The above applies in particular to the flight control device.

In the case of civil aircraft equipped with electric flight control devices (i.e. with electrically controlled actuators), failures are covered by the triplication of electric actuators, of movable surfaces and of associated sensors. Automatic detection and isolation logic schemes are used for detecting and inhibiting faulty element(s).

However, such an architecture for a flight control device can hardly be borne on an aerial drone. It is not only a question of complex architecture (management of a plurality of actuators in redundancy of each other), but above all such an architecture is difficult to bring to the scale a drone, in particular of a light drone (i.e. about 100 kg and 2 to 8 m wingspan), since it requires a division of the movable surfaces, of the axes of rotation thereof, and a multiplication of the actuators and of the position sensors. The above is not very convenient to carry out on wings or tails which are already very thin and narrow. Such an architecture would even introduce additional weaknesses.

In addition, for an aerial drone, the overweight due to a triplication of the actuators is prohibitive, because same has a negative impact on the performance of the drone.

All the above would finally lead to a drone, the manufacturing and maintenance cost of which would be too high.

### SUMMARY OF THE DESCRIPTION

The goal of the present invention is consequently to solve the problem without any impact on the already limited carrying capacities of an aerial drone and more generally of an unmanned aircraft.

To this end, the subject matter of the invention is an unmanned aircraft of the aforementioned type, characterized in that same further comprises a pair of auxiliary propulsion units, mounted movably on the airframe, on both sides of a longitudinal vertical plane of the airframe, each auxiliary propulsion unit including an electric motor, a propeller driven by the electric motor, and means of orienting the plane of the propeller relative to the airframe, the piloting computer being programmed for adjusting an orientation angle and a propeller speed of each auxiliary propulsion unit so as to compensate for a malfunction of the flight control system and/or of the main propulsion unit, in order to control the trajectory of unmanned aircraft along all axes, so that the unmanned aircraft has increased operational reliability.

According to particular embodiments, the aircraft includes one or more of the following features, taken individually or according to all technically possible combinations:
each auxiliary propulsion unit is retractable inside a dedicated fairing provided on the airframe of the unmanned aircraft.
each fairing integrates at least one battery for supplying the electric motor of the auxiliary propulsion unit associated with said fairing.
each auxiliary propulsion unit is mounted at the rear and above the wing.
the tilt angle of the plane of the propellers of the pair of auxiliary propulsion units is adjustable within a range, the thresholds of which are adjustable.
the aircraft has a second pair of auxiliary propulsion units mounted on the airframe on both sides of a longitudinal vertical plane of the airframe, each auxiliary propulsion unit of the second pair of auxiliary propulsion units including a motor and a propeller, each propeller rotating in a fixed plane perpendicular to a yaw axis of the unmanned aircraft
the autopilot computer is programmed for executing a PLC computer program apt to switch from one mode of operation to another, depending on a flight phase of the unmanned aircraft and a current state of operation of the flight control device, of the main propulsion unit and of each pair of auxiliary propulsion units.

A further subject matter of the invention is a method for piloting an unmanned aircraft conforming to the previous aircraft, consisting, upon the occurrence of a malfunction of the main propulsion unit and/or of the flight control device, of using auxiliary propulsion units for controlling an unmanned aircraft trajectory along all axes.

According to particular embodiments, the method includes one or more of the following features, taken individually or according to all technically possible combinations:
the pair of auxiliary propulsion units is controlled by the autopilot computer, so as generate a vector thrust.
each pair of auxiliary propulsion units is controlled, in nominal operation, so as to complement the main propulsion unit and/or the flight control system.

### BRIEF DESCRIPTION OF THE DRAWINGS

The invention and the advantages of the invention will better understood upon reading the following detailed description of the different embodiments of the invention, given only as an illustrative example and not limited to, the description being made with reference to the enclosed drawings, wherein:

FIG. 1 is a schematic perspective view of a first embodiment of an unmanned aircraft according to the invention;

FIG. 2 is a functional representation of the propulsion system and of the flight control system of the unmanned aircraft shown in FIG. 1;

FIG. 3 is a block representation of method for using an unmanned aircraft shown in FIGS. 1 and 2; and,

FIG. 4 is a schematic perspective view of second embodiment of an unmanned aircraft according to the invention.

### DETAILED DESCRIPTION OF EMBODIMENTS

In general, the invention proposes to make an unmanned aircraft more reliable, in particular a single-motor (combustion or electrical) aerial drone, by adding a pair of auxiliary propulsion units, the plane of the propeller of each auxiliary propulsion unit being orientable, in order to remedy a malfunction of the aircraft flight control system, by controlling the trajectory followed by the aircraft along all axes (roll, yaw, pitch) so as to allow the aircraft to continue the mission thereof.

Advantageously, the pair of auxiliary propulsion units can be used for remedying a malfunction of the main propulsion unit of the aircraft. Advantageously again, the pair of auxiliary propulsion units can be used for complementing the main propulsion unit and/or the flight control device in certain phases of use of the aircraft (auxiliary propulsion for take-off or landing, steerability on the ground, etc.).

To provide such operations, the autopilot computer of the unmanned aircraft has then to be reprogrammed in an appropriate manner.

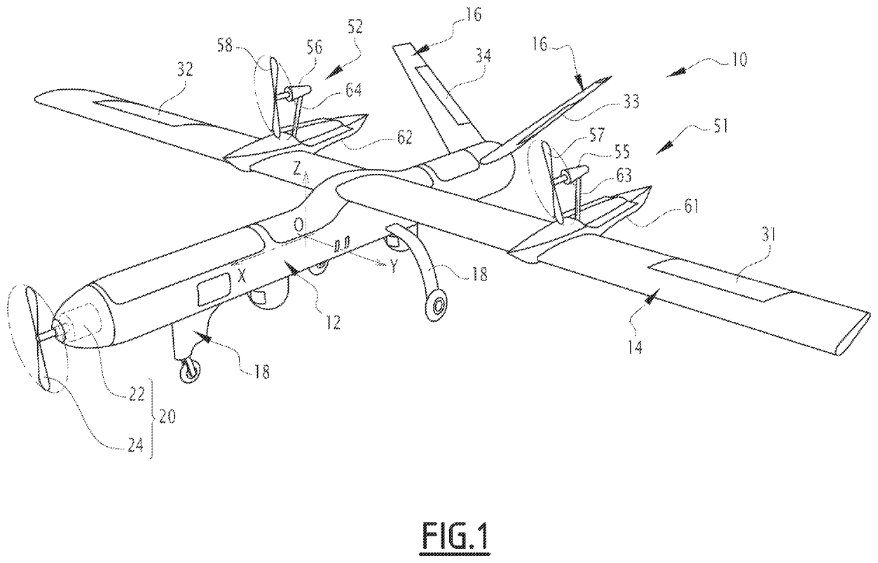

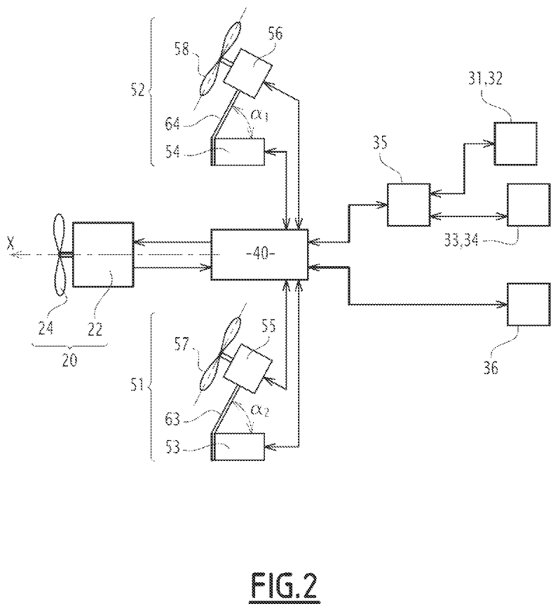

FIGS. 1 and 2 illustrate a second embodiment of an unmanned aircraft according to the invention. It concerns an unmanned aircraft, also called an aerial drone.

The drone 10 is controlled by a remote pilot via a control station.

In a known manner, the drone 10 comprises an airframe. In the embodiment illustrated, the airframe consists of a fuselage 12, a wing 14, a V-shaped tail 16 and a landing gear 18.

In a variant, the airframe includes a plurality of fuselages.

In a variant, other means of landing are provided, such as skis, floats or other.

In a variant, instead of being V-shaped, the tail includes a horizontal stabilizer and a vertical stabilizer.

A coordinate system is associated with the center of gravity 0 of the drone 10. Same has a longitudinal axis X oriented from the rear to the front of the fuselage 12; a transverse axis Y oriented from right to left; and a so-called vertical axis, Z, perpendicular to the plane XY and intended to be parallel to the vertical of the place when the pitch angle (angle of rotation about the axis Y) and the roll angle (about the axis) of the drone are zero. The yaw angle is the angle of rotation around the axis Z.

The drone 10 includes a main propulsion unit 20, including a motor 22 and a propeller 24, e.g. mounted longitudinally, at the front of the fuselage 12. Preferentially, in order to obtain considerable autonomy, the motor 22 is an internal combustion engine rather than an electric motor.

The drone 10 includes a flight control device 30. In the present document, flight control device means an assembly formed by the different movable surfaces (ailerons 31 and 32 on the wing 14 and control surfaces 33 and 34 on the tail 16), as well as the electric actuators for moving same and the sensors for measuring the instantaneous position thereof. In FIG. 2, the plurality of actuators is generally referenced by the number 35 and the plurality of sensors is referenced by the number 36.

According to the invention, the drone 10 includes a pair of auxiliary propulsion units including a first auxiliary propulsion unit 51 and a second auxiliary propulsion unit 52.

Same are arranged on the airframe of the drone 10, symmetrically with respect to the plane XZ of the drone. In the embodiment shown in FIG. 1, the first and second auxiliary propulsion units 51 and 52 are mounted on the wing structure 14, preferentially above and behind the wing.

Each auxiliary propulsion unit is preferentially apt to be retracted into a dedicated fairing provided on the airframe of the aerial drone. Thereby, the drone 10 includes a first fairing 61 on the left wing, for receiving the first group 51 and a second fairing 62 on the right wing, for receiving the second group 52. Each fairing has an aerodynamic shape.

Same is equipped with a hatch which can be opened when the auxiliary propulsion unit is to be deployed or retracted.

The first auxiliary propulsion unit 51 includes a tilt actuator 53, a mast 63, an auxiliary motor 55 and a propeller 57.

The auxiliary motor 55 is preferentially an electric motor.

The first auxiliary propulsion assembly, auxiliary motor 55 and propeller 57, is mounted on the mast 63.

The mast 63 is movable with respect to the airframe of the aerial drone. In the embodiment shown in FIG. 1, the mast 63 is mounted apt to pivot on the airframe about an axis parallel to the axis Y. The tilt angle α1 of the mast 63, evaluated with respect to the axis X, is adjustable by means of the tilt actuator 53. If the propeller 57 is mounted such that the axis thereof is at 90° with respect to the mast 63, the tilt angle α1 is also the tilt angle of the plane of the propeller with respect to the axis X. Preferentially, when the first auxiliary propulsion unit 51 is deployed, the tilt angle is adjustable over a range typically between 45° and 145°, e.g. between 70° and 110° (a tilt angle of 90° indicating that the plane of the propeller is perpendicular to the axis X). The thresholds of the adjustment range of the tilt angle are advantageously adjustable.

Similarly, the second auxiliary propulsion unit 52 includes a tilt actuator 54, a mast 64, an auxiliary motor 56 and a propeller 58.

In particular, the second auxiliary propulsion assembly, auxiliary motor 56 and propeller 58, is mounted on the mast 64, the tilt angle α2 of which, evaluated with respect to the axis X, is adjustable by the tilt actuator 54.

The tilt actuators 53 and 54 are independent of each other and the motors 57 and 58 are independent of each other, so as to control differentially the tilt angle of the masts 63 and 64 and the speed of rotation of the propellers 57 and 58, so as to be able to control the trajectory of the drone 10.

Advantageously, a dedicated power supply battery (not shown) is housed in the first fairing 61 for receiving the first auxiliary propulsion unit 51 for supplying the motor 55 and a dedicated power supply battery (not shown) is housed in the second fairing 62 for receiving the second auxiliary propulsion unit 52. The above is preferable to a common battery installed in the fuselage in order to avoid common failure modes and preserve the effective volumes of the drone fuselage.

The aerial drone 10 includes an autopilot computer 40 which is programmed for determining and transmitting instructions suitable for the main propulsion unit 20 (essentially the speed of rotation of the propeller 24), and to the flight control device 30 (for each actuator 35, the angle of orientation of the movable surface controlled by the actuator), but also to each of the first and second auxiliary propulsion units 51 and 52 (speed of rotation of the propeller 57, 58 and tilt angle of the plane of the propeller α1 and α2).

For example, the computer 40 executes a first computer program for diagnosing the current state of operation of each of the components of the flight control system, namely the flight control device, the main propulsion unit and the pair of auxiliary propulsion units. Each of said components resends status variables to the computer 40 enabling the latter to diagnose the occurrence of a fault or of a malfunction in real time.

The computer 40 uses a second computer program which is preferentially in the form of a state machine apt to switch from one operating mode to another, depending on the flight phase of the drone 10 and the on the state of operation of the different components of the flight control system, as indicated by the first diagnostic program. In a given mode of operation, to determine setpoints, the PLC executes control laws specific to said mode. The different modes of operation will be discussed below during the presentation of an example of use of the drone 10.

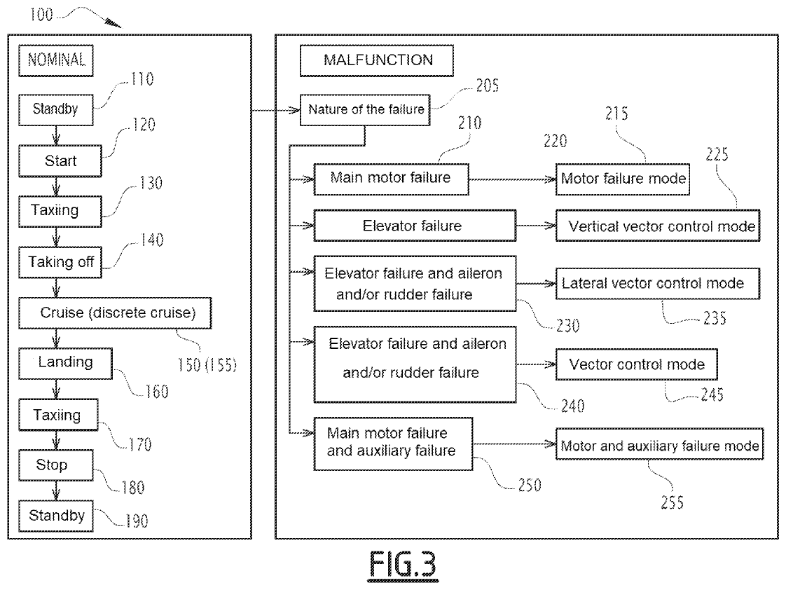

FIG. 3 shows a method for piloting the drone 10. Such method consists of a sequence of steps in nominal operation (i.e. when no malfunction is detected by the first program) and a sequence of steps in case of detection of a malfunction (i.e. when the first program detects a malfunction).

In nominal operation, the drone is initially in a “standby” mode (step 110). The drone is electrically powered, in the parking area, with the main motor 22 switched off and auxiliary propulsion units 51 and 52 retracted inside the respective fairings 61, 62 thereof.

The flight plan is loaded into the autopilot computer 40 by the pilot, from a remote-control station. The pilot initiates the execution of the flight plan.

The PLC executed by the computer 40 then begins a “start” mode (step 120). Same controls the starting of the main motor 22. Advantageously, in order to assist the movement of the drone 10, the computer 40 controls the deployment of the masts 63 and 64 at the vertical (tilt angle of 90°) and the starting of the auxiliary motors 55 and 56, e.g. in an idling speed.

When the pilot activates the taxiing phase, the PLC executed by the computer 40 starts a “taxiing” mode (step 130). Such mode provides for the use of control laws specific to taxiing, in order to control the speed of the two auxiliary motors in a differential way, for guiding along the taxiway plane until aligning with the axis of the runway. The tail 16 of the drone 10 can assist the main and auxiliary motors in order to increase steerability.

When the drone 10 is aligned along the runway axis, the computer PLC starts a “take-off” mode (step 140): the masts 63 and 64 of the auxiliary propulsion units 51 and 52 are tilted at a tilt angle of approximately 70° with respect to the longitudinal axis X and the auxiliary motors 55 and 56 are controlled at full speed, so as to ensure a short take-off.

Once the drone 10 is in flight at a sufficient safety altitude, the PLC starts a “cruise” mode (step 150), wherein the auxiliary motors 55 and 56 are shut down and the masts 63 and 64 are retracted inside the structure, so as to reduce the drag of the drone 10.

If need be, the PLC can start a “discrete cruising” mode (step 155), wherein the main motor 22 is switched off, whereas the masts 63 and 64 are deployed and the auxiliary motors 55 and 56 are activated according to a control law for maintaining the speed. Propulsion is thereby ensured by the auxiliary electric motors and no longer by the main internal combustion engine, which makes it possible to reduce the acoustic signature of the drone 10. The need for discreet cruise operation can be due to environmental requirements, military operations, reduction of nuisance (noise). Such mode is engaged/disengaged at the request of the pilot or programmed in the flight plan.

At the end of the flight, on final approach to the runway, the PLC of the computer 40 engages a “landing” mode (step 160): the masts 63 and 64 are deployed and the auxiliary motors 55 and 56 are activated so as to produce a braking effect of the drone 10, in order to make a short landing at the moment of the contact with the ground.

Once on the ground, the PLC engages the “taxiing” mode (step 170) to the parking point of the drone 10.

The PLC executed by the computer 40 then engages a “stop” mode (step 180).

The drone is again in the “standby” mode (step 190).

At any time, in the event of detection of a malfunction by the first diagnostic program executed by the computer 40, the control method 100 consists in carrying out the following steps, depending on the nature of the failure identified by the diagnostic module (step 205).

When the detected malfunction corresponds to a failure of the main motor 22 (step 210), the PLC executed by the computer 40 engages a “motor failure” mode (step 215): the masts 63, 64 are then deployed (if same were not already deployed) and tilted at 90° and the auxiliary motors 55 and 56 are activated according to a control law for maintaining the speed.

When the detected malfunction corresponds to a failure of the elevator (step 220), the controller engages a “vertical vector control” mode (step 225). In such mode, the masts 63 and 64 are deployed and tilted at a tilt angle allowing the drone 10 to be controlled vertically. A control law controls the speed of the auxiliary motors 55 and 56, for changing the slope of the trajectory followed by the drone 10. For example, with a tilt angle of less than 90°, e.g. of 80°, the drone 10 gains altitude and with a tilt angle greater than 90°, e.g. of 100°, the drone loses altitude. Thus, the symmetrical tilt of the two masts make vectorial control of the unmanned aircraft possible in the vertical plane (i.e. along the pitch axis Y), generating by appropriate control laws, a climb or a descent at the desired rate.

When the detected malfunction corresponds to a failure of the ailerons and/or of the rudder (step 230), the controller engages a “lateral vector control” mode (step 235): the masts 63, 64 are deployed and tilted vertically and a control law controls the speed of the auxiliary motors 55 and 56 in a differential way, in order to make the desired turn. For example, while the auxiliary motors are rotating at the same speed, the speed of the right auxiliary motor 56 is decreased and/or the speed of the left auxiliary motor 55 is increased, so as to make a right turn. The greater the difference in the speed of rotation of the propellers 57 and 28, the tighter the turn will be. If need be, the masts can be controlled in differential tilt so to increase the lateral effect of the vector thrust. Such control mode complements the effect of the side control surfaces which are still available. Thereby, the asymmetrical speed of the two propellers causes a differential control generating a response of the aircraft along the yaw axis Z inducing a response along the roll axis X, which, by means of appropriate control laws, makes it possible to make a coordinated turn at the desired rate. If need be, such asymmetrical speed control can be assisted by differential tilt of the masts.

When the detected malfunction corresponds to a combined failure of the elevator, the ailerons and the rudder (step 240), the controller switches to a “vector control” mode (245): the masts 63 and 64 are deployed vertically and a control law controls both the speed of the auxiliary motors 55 and 56 and the tilt angle of the masts 55 and 56 so as to control the aircraft in the horizontal plane and in the vertical plane. Such mode combines and generalizes the two previous modes. Maneuverability along the three axes X, Y and Z is thereby recovered.

When the detected malfunction corresponds to a failure of one of the auxiliary motors after a failure of the main motor (step 250), the controller goes into a “motor and auxiliary failure” mode (255) wherein the control of the speed of the drone 10 is done with the residual auxiliary propulsion unit (in rotation speed of the auxiliary motor thereof and tilt angle of the propeller thereof).

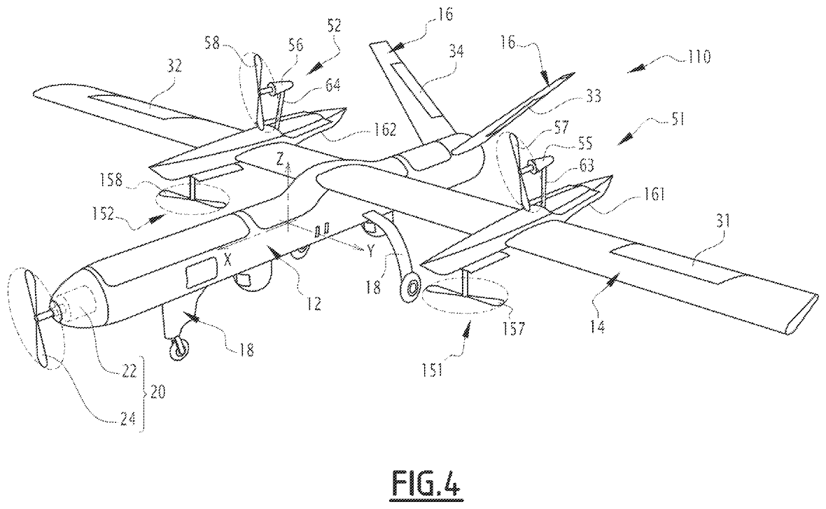

FIG. 4 represents a second embodiment of the unmanned aircraft according to the invention. It also concerns an aerial drone.

Drone equipment 110 shown in FIG. 4 identical to equipment of the drone 10 shown in FIG. 1 is referenced by a number which is equal to the number by which the identical equipment is referenced. The drone equipment shown in FIG. 4 similar to the drone equipment shown in FIG. 1 is referenced by a number which is equal to the number by which the similar equipment is referenced, increased by one hundred.

The drone 110 differs from the drone 10 only in that same includes two pairs of auxiliary propulsion units, a first pair 51, 52 at the rear and above the wing 14 and a second pair 151, 152 at the front and below the wing 14.

As in the first embodiment, the plane of the propeller of each auxiliary propulsion unit of the first pair can be tilted. Preferentially, in the second embodiment, the tilt angle varies between e.g. 0° (propeller 57, 58, in horizontal position) and, e.g. 110° (plane of propeller 57, 58, beyond the vertical).

In order to simplify the operation of the drone, the planes of the propellers 157 and 158 of each auxiliary propulsion group of the second pair 151 and 152 are preferentially fixed. In the second embodiment, the plane of the propellers lies e.g. in a plane parallel to the plane XY (tilt angle of 180°).

Thereby, the drone 110 can take off vertically.

The method for using the drone 110 is substantially identical to same for the drone 10 except that the method can be further used, in nominal operation, for a vertical take-off. The PLC implemented by the computer 140 thus provides additional modes:

For a vertical take-off phase, the two front propellers 157 and 158 and the two rear propellers 57 and 58 tilted horizontally are controlled at full speed.

Then, for a phase of transition towards horizontal flight once a safety altitude has been reached, the masts 63 and 64 are progressively tilted from 0° to 90° and the main motor 22 is started.

Then, for a cruise phase once the horizontal speed of the drone 110 is sufficient, the front and rear propellers are shut-down and the auxiliary propulsion units are retracted into the fairings 161, 162.

In a variant, instead of adjusting only the tilt angle of the masts (and hence the planes of the propellers) of the auxiliary propulsion units with respect to the axis X of the drone, it is conceivable to also adjust the pivot angle of the axis of each propeller about the mast thereof. Thus, the orientation of the plane wherein a propeller rotates is orientable according to two degrees of freedom. Corresponding actuators are then added to each auxiliary propulsion unit and the computer is programmed so as to generate setpoints for adjusting the pivot angle, preferentially independently for each unit.

The auxiliary propulsion units thus added, beyond the propulsion effect that same can provide (in particular during landing and take-off under normal conditions), are used for controlling the trajectory of the drone along all axes (roll, pitch and yaw) in the event of failure of the primary flight control device. The above thus makes it possible to improve the reliability of the drone without having to implement redundancy by identical technical means (i.e. a duplication or even a triplication of the equipment of the flight control device), but a redundancy by non-identical technical means.

The auxiliary propulsion units and the associated control laws make it possible to achieve vector thrust: the thrust can be oriented in all directions by the conjunction of the variable tilt and of the variable speed of each of the auxiliary propulsion units. The orientation of such vector thrust according to the desired direction makes it possible to control the speed, the thrust and the drag of the aerial drone, in addition to the trajectory.

The proposed solution addresses the issue of drone reliability, while remaining easy to implement, and without having any impact on the carrying capacity of the drone. Such solution is easy to implement for upgrading existing drones.

1. An unmanned aircraft, comprising:
an airframe, comprising:
a fuselage;
a wing; and
a tail;
at least one main propulsion unit, comprising:
at least one motor; and
at least one propeller;
a flight control device, comprising:
a plurality of electric actuators;
movable surfaces; and
sensors;
an auto-pilot computer, sending instructions to said at least one main propulsion unit and to said flight control device;
a pair of auxiliary propulsion units, mounted movably on said airframe, on both sides of a longitudinal vertical plane of said airframe, each auxiliary propulsion unit comprising:
an electric motor;
a propeller driven by said electric motor; and
means for orienting a plane of said propeller relative to said airframe, said auto-pilot computer being programmed for adjusting a steering angle and a propeller speed of each auxiliary propulsion unit so as to compensate for a malfunction of said flight control device or of one or more of said at least one main propulsion units, in order to control a trajectory of unmanned aircraft along all axes, so that the unmanned aircraft has an increased operational reliability.

2. The aircraft according to claim 1, wherein each auxiliary propulsion unit is retractable within a dedicated fairing provided on said airframe.

3. The aircraft according to claim 2, wherein each fairing integrates at least one battery for supplying said electric motor of each auxiliary propulsion unit associated with the fairing.

4. The system according to claim 1, wherein each auxiliary propulsion unit is mounted at the rear of and above said wing.

5. The aircraft according to claim 1 wherein a tilt angle of the plane of said propellers of said pair of auxiliary propulsion units is adjustable within a range, the thresholds of which are adjustable.

6. The aircraft according to claim 1, further comprising a second pair of auxiliary propulsion units mounted on said airframe on both sides of a longitudinal vertical plane of said airframe, each auxiliary propulsion unit of the second pair of auxiliary propulsion units comprising:
a motor; and
a propeller, each propeller rotating in a fixed plane perpendicular to a yaw axis of the unmanned aircraft.

7. The aircraft according to claim 1, wherein said auto-pilot computer is programmed for executing a PLC computer program capable of switching from one mode of operation to another, depending on a phase of flight of the unmanned aircraft and of a current state of operation of said flight control device, of said at least one main propulsion unit (20) and of each pair of auxiliary propulsion units.

8. A method for piloting an unmanned aircraft according to claim 1, comprising, upon occurrence of a malfunction of said at least one main propulsion unit or of said flight control device, using said pair of auxiliary propulsion units for controlling a trajectory of the unmanned aircraft along all axes.

9. The method according to claim 8, wherein said pair of auxiliary propulsion units is controlled by said auto-pilot computer, so as to generate a vector thrust.

10. The method according to claim 8, wherein each pair of auxiliary propulsion units is controlled, in nominal operation, so as complement said at least one main propulsion unit or said flight control device.
